(19) United States
(12) Patent Application Publication
(10) Pub. No.: US 2023/0239314 A1
(43) Pub. Date: Jul. 27, 2023

(54) RISK MANAGEMENT SECURITY SYSTEM

(71) Applicant: Living Security, Inc., Austin, TX (US)

(72) Inventors: Drew Rose, Spicewood, TX (US); James M. Dew, Austin, TX (US); Christopher L. Poirel, Pawley's Island, SC (US); Brandon J. Telle, West Hills, CA (US)

(21) Appl. No.: 18/069,019

(22) Filed: Dec. 20, 2022

Related U.S. Application Data
(60) Provisional application No. 63/302,284, filed on Jan. 24, 2022.

(51) Int. Cl. H04L 9/40; G06Q 10/0639

(52) U.S. Cl. CPC H04L 63/1425; H04L 63/20; G06Q 10/0639

(57) ABSTRACT

Systems and methods are disclosed for a risk management security system. In certain embodiments, a method may comprise performing a risk evaluation via a risk management security platform (RMSP), including receiving activity data for a risk-oriented event corresponding to a user participant, and generating an insight providing an evaluation of risk for the user participant in a risk category based on the activity data. The method may further comprise generating a risk score for the user participant based on the insight, and providing a notification based on the risk score.

### CROSS-REFERENCE TO RELATED APPLICATION

The present application claims priority to pending U.S. provisional patent application, Application No. 63/302,284, filed Jan. 24, 2022, entitled “Risk Management Security System”, the contents of which are hereby incorporated by reference in their entirety.

### SUMMARY

In certain embodiments, a method may comprise performing a risk evaluation via a risk management security platform (RMSP), including receiving activity data for a risk-oriented event corresponding to a user participant, and generating an insight providing an evaluation of risk for the user participant in a risk category based on the activity data. The method may further comprise generating a risk score for the user participant based on the insight, and providing a notification based on the risk score.

In certain embodiments, an apparatus may comprise a processor configured to implement a risk management security platform (RMSP) to perform a risk evaluation, including: obtain activity data for a risk-oriented event corresponding to a user participant, generate an insight providing an evaluation of risk for the user participant in a risk category based on the activity data, generate a risk score for the user participant based on the insight, and provide a notification based on the risk score.

In certain embodiments, a memory device may store instructions that, when executed, cause a processor to perform a method comprising performing a risk evaluation via a risk management security platform (RMSP), including receiving activity data for a risk-oriented event corresponding to a user participant, and generating an insight providing an evaluation of risk for the user participant in a risk category based on the activity data. The method may further comprise generating a risk score for the user participant based on the insight, and providing a notification based on the risk score.

### BRIEF DESCRIPTION OF THE DRAWINGS

FIG. 1 is a diagram of a risk management security system, in accordance with certain embodiments of the present disclosure.

FIG. 2 depicts a process flow diagram of a risk management security system, in accordance with certain embodiments of the present disclosure.

FIG. 3 is a diagram of a risk management security system, in accordance with certain embodiments of the present disclosure.

FIG. 4 is a diagram of a risk scoring model of a risk management security system, in accordance with certain embodiments of the present disclosure.

FIG. 5 is a diagram of a risk scoring model of a risk management security system, in accordance with certain embodiments of the present disclosure.

FIG. 6 is a diagram of a risk scoring model of a risk management security system, in accordance with certain embodiments of the present disclosure.

FIG. 7 is a diagram of a risk scoring model of a risk management security system, in accordance with certain embodiments of the present disclosure.

FIG. 8 is a diagram of a risk scoring model of a risk management security system, in accordance with certain embodiments of the present disclosure.

FIG. 9 is a diagram of a risk scoring model of a risk management security system, in accordance with certain embodiments of the present disclosure.

FIG. 10 is a diagram of a risk scoring model of a risk management security system, in accordance with certain embodiments of the present disclosure.

FIG. 11 is a diagram of a risk scoring model of a risk management security system, in accordance with certain embodiments of the present disclosure.

FIG. 12 is a diagram of a computing system configured to implement a risk management security system, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

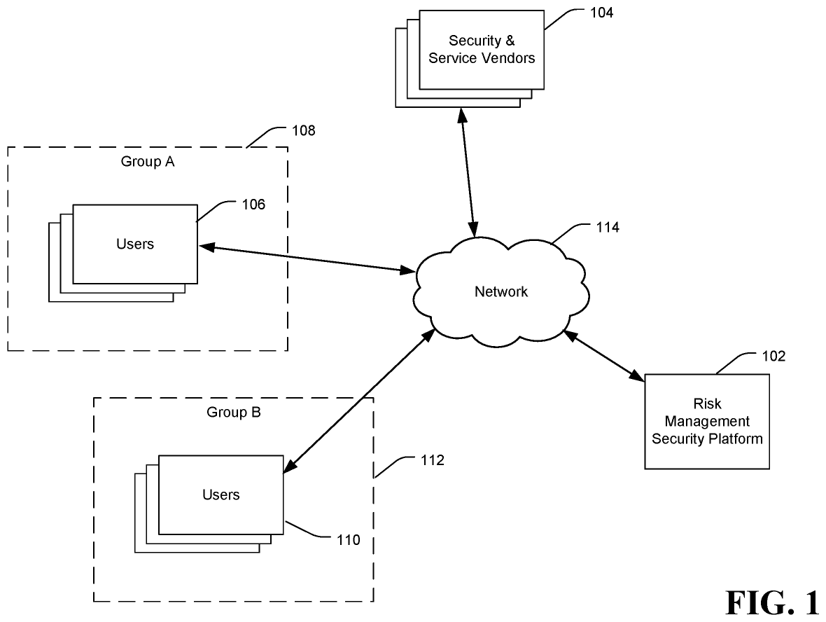

FIG. 1 is a diagram 100 of a risk management security system, in accordance with certain embodiments of the present disclosure. In particular, FIG. 1 depicts a number of systems and components that may be configured to assess behavior that may constitute a security risk, generate notices and records regarding behavior patterns in users of the system, and formulate and implement action plans to address behavior determined to be risky. The system may include a risk management security platform (RMSP) 102, one or more security and service vendors 104, a first set of one or more users 106 in a first group A 108, and a second set of one or more users 110 in a second group B 112. Components of the system may communicate via one or more networks 114, such as wide-area network (WAN) or local-area network (LAN) systems, intranets, the internet, or other networks, and via wired or wireless communication mediums, switches, routing systems, and other components of network(s) 114.

Computer security has become an increasingly important aspect of personal and business considerations. Breaches in data security can lead to serious losses, including economic harm, loss of access to records or systems from ransomware attacks, public image harm due to hijacked social media accounts or leaks of customer data, or various other harms. Security breaches can stem from several root causes, including vulnerabilities in outdated software, compromised login credentials, malware installed through unsafe web pages, or various other sources.

Users 106 and 110 may be individual users, user accounts, computing systems associated with users, or some other individual element for which risk-oriented behavior can be monitored. Users 106 and 110 may be monitored and evaluated for risk-oriented behavior based on their membership in some organization or class. For example, users 106 and 110 may be employees of a company that wishes to limit exposure to risk based on employee behaviors. Details on some of these risk factors may be available from different sources, such as listings of compromised credentials posted on the internet, virus scan software vendors, operating system or browser update listings, or other sources. Some security considerations may not be readily available to users, such as details of their own web browsing or email access histories that may be unsafe, or geolocation data that may indicate suspicious activity. Attempting to keep updated with all the various resources for an individual may be difficult, and attempting to monitor the behaviors and security risks of one or more groups of people may be impractical. Even after gathering the distributed resources and data available, the data may be difficult to parse, and it may be unclear how best to respond to the security data. Accordingly, a risk management security system 102 configured to compile and monitor risk-based behaviors and data can provide a solution to the increasing need for maintaining high security standards, especially across groups of users. The RMSP 102 may use the combined data to generate easily-understood security posture summaries, and may generate guidance regarding addressing any identified security vulnerabilities.

Users 106 and 110 may be subdivided into a plurality of groups, such as group A 108 and group B 112. The groups 108 and 112 may be categories of users that share some feature that may be useful for making broader risk assessments about groups rather than individuals. For example, groups 108 and 112 may include users in different departments within a company, users from different geographical regions, may be based on user demographics, based on other factors, or combinations thereof. In some examples, a particular user may only belong to one group, while in other examples users may be included in multiple groups. For example, a user Bob may be included in group A for being employed in an accounting department, and also included in group B for being situated in New York.

Details and instances of risk-oriented behavior may be captured or organized at multiple points in the system. For example, modules of computing systems used by users 106 and 110 may log risk-based behavior, such as via software that logs what websites are visited, what web browser is used, how updated operating systems or programs are on the user's system, suspicious or harmful files detected by security software, or other details. Details of risk-oriented behavior may also be captured or monitored by one or more security and service vendors 104, which may receive updates from systems of users 106 and 110. Security and service vendors 104 may include antivirus or security software vendors, email vendors, web browser vendors or hosts, security training vendors, or other systems and providers. The details may be captured or stored at computing systems, servers, databases, or other components of security and service vendors 104, where the data may be accessed by outside sources, potentially based on the outside sources having trusted credentials and access rights. For example, the security and service vendor 104 services may be retained by a company to monitor risk-oriented behavior by its employees or customers 106 and 110, and the company may be permitted to access security details via an application program interface (API) of the vendor. The company may be able to access the details directly, or via a risk management security platform 102. Additionally, the risk management security platform 102 may capture risk-oriented activity itself directly from user 106 and 110 systems, or otherwise from monitoring user behavior, and may also compile risk-oriented activity data from one or more security and service vendors 104.

The risk management security platform 102 may be a service provider, a computing module, a distributed computing system, or other system platform for risk management, and may sometimes be referred to as “Unify”. The RMSP 102 may be configured for acquiring activity data, evaluating the activities for calculating risks and trends, generating insights, reports, notices, or recommendations regarding the evaluation results, and in some examples implementing corrective action plans or training routines to address identified risky behaviors. The RMSP 102 may acquire user 106 and 110 details and activity records from a variety of sources, including from the user 106 and 110 systems, from the security and service vendors 104, and from an entity or company that seeks to minimize security risks from security-oriented behavior of the users 106 and 110. In some examples, users 106 and 110 may employ the RMSP's services to monitor their own behavior, to learn what actions may be creating security risks in their own lives.

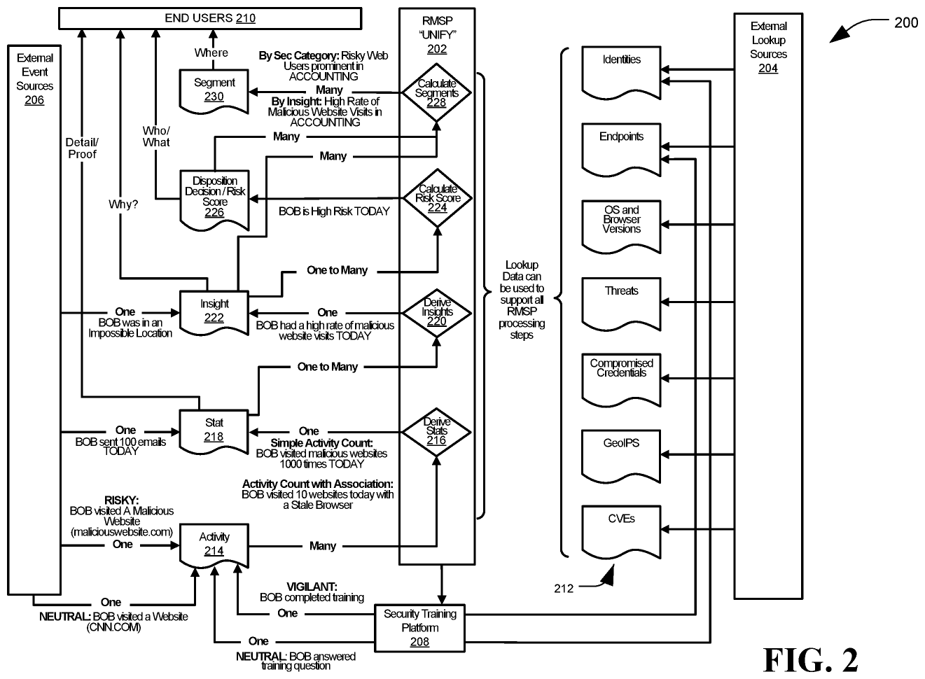

The RMSP 102 may normalize or standardize the data received from the various sources so that it can be utilized in source-independent data structures and models. This normalization process may include recognizing the types of data from the various sources, discarding data that is not employed in the RMSP's models, converting the useful data into a standardized format, and then evaluating the standardized models to generate insights, reports, and action plans. The insights, reports, and action plans may be formatted and provided to customers in easily understood formats, such as human-speech sentence notices or reminders, charts or graphs, or other notices. The insights and reports may provide generalized security advice (e.g., “high volume of suspicious web activity today for user Bob”), or more specific instances of security issues (e.g., “Bob accessed the following unsafe websites at these times:”). Action plans may include automatically generating emails or messages to send to users 106 and 110 regarding observed unsafe behaviors or security vulnerabilities, generating software update lists that may be implemented by users 106 and 110 or a security administrator for a company, or generating training materials designed to address unsafe behaviors. For example, the RMSP 102 itself, or a security training vendor 104, may provide a curriculum of online training courses for users 106 and 110 that may be more prone to risky behavior. Completion of security training may be logged and included as risk-oriented behavior activity by the RMSP 102 in evaluating the security risk for users or groups. The process for acquiring activity and event data, evaluating the data, and providing reports and notices is described in regard to FIG. 2.

FIG. 2 depicts a process flow diagram 200 of a risk management security system, in accordance with certain embodiments of the present disclosure. In particular, FIG. 2 depicts an example process flow for acquiring activity and event data, processing and evaluating the data, and providing reports and insights regarding security details to a user 208 of the RMSP 102 system. The diagram 200 depicts the RMSP “Unify” platform 202, external lookup sources 204 and external event sources 206, a security training platform 208, and end users 210 of the RMSP.

The following table provides some example terminology and details for elements employed or considered by the RMSP 202.

| Term | Definition |
|---|---|
| Entity | A “thing” that the RMSP might want to observe or understand over time. |
| | Identity, Endpoint, Resource, IP Address, Client, and Threat are example |
| | entity types that an RMSP can capture. Entities can have attributes. |
| Attribute | A characteristic of an Entity. Bob Smith (entity) has “first_name” of |
| | “Bob” - “first_name” may be an attribute. |
| Alias | A unique identifier for an Entity. |
| | Aliases can have a TYPE, as well as raw, normalized, and pseudonymized |
| | values. |
| | Aliases may be used for Entity Resolution. |
| | Ex: Alias{ |
| | type: EMAIL_ADDRESS, |
| | raw: “USER@gmail.com”, normalized: “user@gmail.com”, |
| | pseudonymized: “12345098122” |
| | } |
| Identity | An entity representing a Person, User, User Account, or User |
| | Claim/Credential. |
| | Identities can have multiple Aliases. |
| Endpoint | An entity representing a machine (laptop, desktop, server, etc.). |
| | Endpoints can have multiple Aliases. |
| | Endpoints can have normalized Operating System and Device Type |
| | details. |
| Resource | An entity representing a thing that is accessed (file, directory, website, |
| | cloud service, etc.). |
| | Resources can have multiple Aliases. Resources can have a Type (e.g., |
| | FILE, DIRECTORY). |
| IP Address | An entity representing an IPv4 or IPv6 address. |
| | IP Address can have a single Alias. |
| | IP Addresses can have GeoLocations (e.g., latitude, longitude, city, state, |
| | region). |
| Client | An entity representing a software application utilized in an Activity - |
| | for instance, a Web Browser. |
| | Clients can have a single Alias. |
| | Clients can have a TYPE (e.g., web browser, etc.) and can have a version |
| | and an Operating System. |
| Threat | An entity representing a named/resolvable threat inherent in or present in |
| | an Activity. |
| Participant | An Entity that is the subject of an Activity - e.g., that was the SOURCE or |
| | TARGET of the Activity - and for which a Disposition can be calculated |
| | and understood over time. May only include Identity and Endpoint. |
| Security | A semantically meaningful category used to group related Activities, |
| Category | Statistics, and Insights. E.g., |
| | Phishing & Email; |
| | Device Security; |
| | Web Security; |
| | Access and Authentication; |
| | Training and Assessments; |
| | Data Security and Privacy. |
| Disposition | A categorical assessment of the nature of an Activity, Entity, Insight, or |
| | Segment. Can be either fixed, or determined at a point in time. |
| | E.g., NEUTRAL / RISKY / VIGILANT |
| Severity | A categorical assessment of the relative degree of risk or vigilance |
| | inherent in an Activity Type |
| | E.g., LOW / MEDIUM / HIGH |
| Activity | A semantically meaningful label for an Activity. |
| Type | Ex: website.malicious.clicked |
| Activity | A single event that comes directly from a source indicating that something |
| | was done at a point in time by an Entity or Entities. |
| | May have: a timestamp; an Activity Type; a Disposition; a Severity. |
| | May have 0 to Many of each of: Identities, Endpoints, Resources, |
| | Clients, IP Addresses, and Threats |
| Statistic | A rollup or aggregation of Activities. A Statistic can come directly from |
| (Stat) | an external source in the form of an event, or can be calculated by the |
| | RMSP. |
| | May have a Disposition |
| Insight | An assertion made about a Statistic, Participant, or Participant/Entity |
| | Attribute, or combination of any/all of the above that may be paired |
| | with industry expert logic. Insights may be the user- understandable |
| | “Why” with regard to risk or vigilance. |
| | May have 1 or More Security Categories. |
| | May have a Disposition. |
| Impact | An attribute of an Entity (Identity) that may influence their risk score. |
| Modifier | Examples: VIP, Privileged Access, Tenured, Active Identity, Inactive |
| | Identity |
| Disposition | An assertion that a Participant has a particular Disposition in a Security |
| Decision, or | Category (e.g., Web, Email, etc.) at a point in time. Can be a categorical |
| Risk Score | score based on an evaluation of Insights and Impact Modifiers indicating |
| | whether an Identity is High Risk, Moderately Risky, Neutral, Moderately |
| | Vigilant, or Highly Vigilant. |
| | The “What” that the user needs to be concerned with. |
| Segment | A group of Participants that share common attributes. Can be understood |
| | independent of Disposition, or presented with only those who have the |
| | same Disposition for a Security Category at a point in time. |
| | Segments enable an understanding of where risk or vigilance is most |
| | prominent in an organization, or where particular Insights or |
| | combinations of Insights are most prevalent. |
| | Ex: Job Title: Engineer, Location: Miami |

An example Activity may have the following characteristics:
When it happened—a timestamp.
Who initiated it—SOURCE Entities and their attributes.
Who was affected by it—TARGET Entities and their attributes.
The threats inherent in the Activity—THREAT Entities (e.g., Malicious File) and their attributes.
A list of event types comprised of the following:
   A label indicating what the Activity happened against: an “Object”—a noun: e.g., “website”, “file”, “user”
   A label indicating Action taken against the noun—an “Action”—a verb: e.g., “clicked” “visited”
   A label indicating the nature of the noun: an adjective: e.g., “malicious”.
   A label indicating the outcome of the verb: an “Outcome”—another verb: e.g., “failed”.
   A Disposition—RISKY, VIGILANT, or NEUTRAL. Determined by combination of the verb, noun, and adjective.
   A Security Category—Web, Email, etc.

With the above terminology and examples in place, FIG. 2 shows an example flow of information or data from sources (204, 206, 212, and 208) to end users 210, and how the RMSP 202 data elements described above are generated and applied.

External lookup sources 204 and external event sources 206 may include security and service vendors 104, the computing systems or software of users 106 and 110, employer databases, or other data sources that may be accessed by the RMSP 202, or the data received therefrom. Some individual sources 212 may include identities, endpoints, and OS and browser versions for the users 106 and 110 being evaluated, known threats, compromised credentials and CVEs (common vulnerabilities and exposures), GeoIPS (geo-located information processing system) data, among others. One or more security training platforms 208 may also provide security data. The data may be accessed via API calls or other access requests from the RMSP 202 to databases and systems, submitted to or received at the RMSP 202, or otherwise obtained. Information from external lookup sources 204 and 212 may be used to make security evaluations, such as determining when outdated OS and browsers are being used, identifying known viruses or security threats, looking up user names and passwords that have been leaked online, or other for making other security evaluations.

The RMSP 202 may receive activity data 214 from various sources. For example, collections of multiple individual activities (e.g., a single website access event) may be received by the RMSP 202, either individually or aggregated into sets (e.g., all activities received within the last hour may be cached together and then processed by the RMSP 202, or the RMSP 202 may periodically retrieve all new accumulated activities from external sources, normalize them, and process them together).

Based on the activities 214, the RMSP 202 may, at 216, derive stats 218 based on activities for individual users, e.g., over some specified period of time. The stats 218 may also be obtained from eternal event sources 206. These stats 218 may be provided to end users 210 as evidentiary details or proof for security notifications and evaluations the RMSP 202 may provide.

The stats 218 may also be processed by the RMSP 202, at 220, to derive insights 222, which may also be obtained from external event sources 206. Insights may represent evaluations of what behaviors or activity trends for a user may represent risky or notably safe behavior. These insights 222 may be provided to end users 210 as a “why” or justification of overall security conclusions of the RMSP 202.

The insights 222 may be aggregated and evaluated, at 224, for overall risky trends or individuals to calculate or generate a disposition decision or risk score 226 in a security category. These disposition decisions or risk scores 226 may be provided to end users 210 as a “who” and “what” indicator for security-oriented issues.

Further, the insights 222 and security dispositions 226 may be used to evaluate or calculate, at 228, a segment 230, which may correspond to the groups 108 and 112 of FIG. 1. These segment 230 calculations may determine overall security trends for groups based on the individual insights and disposition decisions of individuals or participants within the group. These segments 230 may be provided to end user 210 as a “where” indicator for where security issues or strong security exist in the various groups.

For example, an end user 210 may access or be notified by the RMSP 202 of the following risk overview or notification:

WHERE (Segment 230): “Risky web users are prominent in accounting”, or “there is a high rate of malicious web visits in accounting”.
WHO & WHAT (Disposition Decision/Risk Score 226): “Bob (in accounting) is a risky user or web user today”, and potentially notifications about other users in accounting.
WHY (Insight 222): “Bob had a high rate of malicious website visits today”, and potentially details such as “Bob was in an impossible location” based on geolocation data.
DETAIL & PROOF (Stat 218): “Bob visited malicious websites 1000 times today, and visited 10 websites with a stale (non-updated) browser.”
Based on these details, and end user 210 may receive security evaluations of groups and individuals, as well as specific details of what activities and behavior gave rise to the evaluations.

In a more specific example, starting from the top of the diagram 200:
The End User 210 wants to know “Where in my Organization is there Risky Web usage?” They see that today, there is a Segment 230 indicating that ACCOUNTING is showing a lot of Risky Web Usage (e.g., Many Entities in that Segment have a Risky Disposition in the Web Security Category).
The End User 210 wants to know “Who specifically?” and drills into the Segment 230, and sees a “Bob is a Risky Web User Today, and has been for X amount of time”, which is captured as a Risky Disposition Decision 226 for Bob in the Web Security Category at a point in time and for a period of time.
End User 210 wants to know “Why does Bob have a Risky Web Disposition?”-they see Insights 222 that led to the Disposition Decision 226, one of which is “Bob had a high rate of malicious website visits today relative to the population”
End User 210 wants Proof. They inspect Stats 218 that led to the Insight 222, such as “Bob visited malicious websites 1000 times today”.
End User 210, or the RMSP system 202 take some action on Bob or the Segment 230.

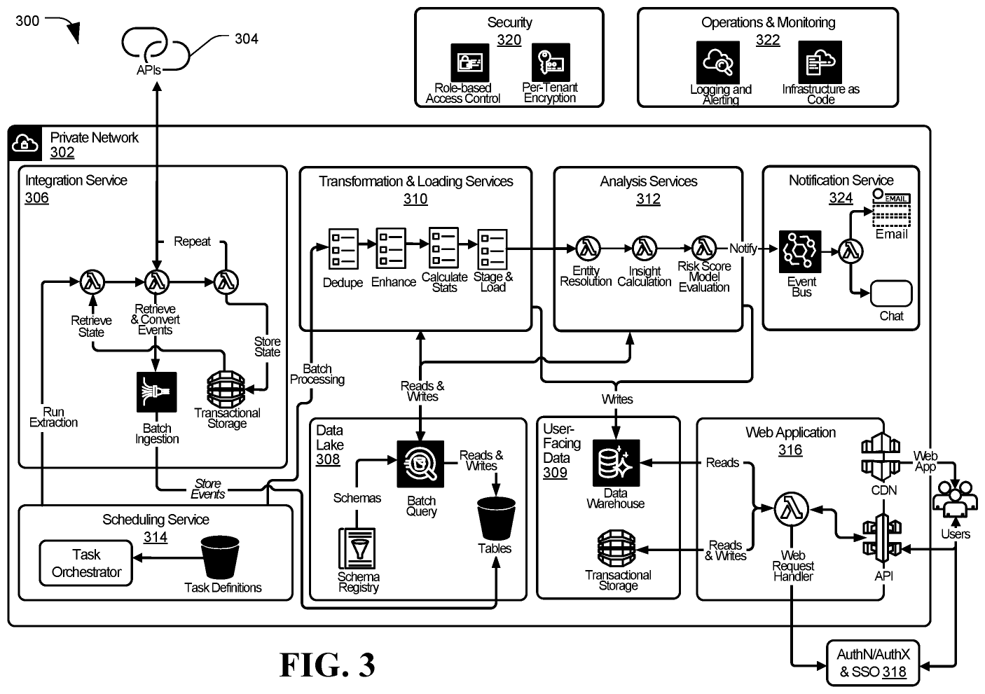

In some examples, the insights 222, disposition decisions 226, and segments 230 may be used to determine training or corrective actions to implement. For example, emails or chat messages may be sent to users who are displaying high-risk behavior to help them identify and correct actions that may create vulnerabilities. The evaluations may also be used to generate security training curricula, via security training platform 208, to address the identified behaviors. For example, training courses on secure web-browsing practices may be provided to users in the accounting department. Completion of training courses may reduce the risk assessment of individuals who participated in the courses. An example structure of the RMSP 202 is shown in FIG. 3.

FIG. 3 is a diagram of an example risk management security system 300, in accordance with certain embodiments of the present disclosure. The system 300 may be implemented as a variety of modules, which may be implemented in a distributed fashion via cloud computing services, or on dedicated hardware and server implementations. For example, the system 300 may be implemented as an AWS (Amazon web services) managed service, with ephemeral, serverless implementation for portions, and infrastructure as code. “Ephemeral” services (and their associated resources) may be spun up only as-needed for its task, whereas other services and resources may be active at all times. For example, when a user visits the UI, resources may be temporarily spun up to service those requests and visualize the services on a frontend. The illustrated system may provide elasticity in scale within and across tenant (e.g., client or customer) partitions, with per-tenant logical data isolation and encryption.

The RMSP may be implemented via a private network 302, such as a virtual private cloud. The private network 302 may include modules such as an integration service 306, a data lake 308, user-facing data 309, transformation and loading services 310, analysis services 312, notification service 324, scheduling service 314, and web application 316. Further, the RMSP may include features for security 320, operations & monitoring 322, or other features.

The scheduling service 314 may orchestrate the processing that happens in the majority of the RMSP services, such as extract, transform, and load (ETL) operations performed by the integration service 306 and transformation and loading services 310. ETL may refer to the general procedure of copying data from one or more sources into a destination system which represents the data differently from the sources, or in a different context than the sources. Scheduling service 314 may manage scheduling using a task orchestrator module and a task definitions module. The task definitions module may include a database or other data structure storing definitions and other details for tasks to be performed by various modules of the RMSP. The orchestrator module may utilize the information in the task definitions data structure for sending task scheduling messages to the various services and components of the RMSP. For example, the scheduling service 314 may trigger the retrieval of data by the integration service 306 as depicted in the “Run Extraction” line. The scheduling service 314 may also trigger the processing done by the transformation & loading services 310 and analysis services 312 as depicted in the “Batch Processing” line, and the signal line connecting the transformation & loading services 310 to the analysis services 312.

The integration service 306 may be responsible for retrieving data from external sources (e.g., security and service vendors) via third party vendor APIs 304, converting the data to a standard format, storing that data in the data lake 308, and keeping track of what data has been retrieved so that new data can be retrieved in the future. Retrieved data may represent “events” or “activities” that may have a bearing on an Entity's security profile.

The integration service 306 may be triggered on schedules defined in the scheduling service 314. When triggered, integration service 306 may retrieve (e.g., from a transactional storage data structure) the current state of each integration, where an integration may refer to data from an external data source being integrated into the RMSP system. The integration service 306 may use that state to determine whether new data should be retrieved, based on information in the state indicating what was last retrieved and configuration information dictating how frequently data should be retrieved. For each integration that has new data to be retrieved, the integration service 306 may perform the following:
Retrieves the latest data for that integration according to configurable parameters defined in the retrieved state, such as integration-specific filter and pagination criteria;
Converts the retrieved data to a standard, integration-independent format;
Stores the converted data (“events”) into the data lake 308 via the batch ingestion path;
Stores the updated state in transactional storage of the integration service 306;
Repeats the above steps up to a configurable number of times until there is no more data to retrieve; and
Completes processing.

The data lake 308 may be a repository for structured or unstructured data that may be managed and accessed in performing the RMSP's operations. The data lake 308 may include one or more tables or other data structures in which the data elements are stored, and a schema registry which may define how the data is organized and related. A batch query module may handle read and write requests, in conjunction with the schema registry, to handle data access operations from elements of the RMSP, such as the transformation and loading services 310 and the analysis services 312. Elements of the data lake 308 may be stored to one or more data storage mediums, such as hard drives, solid state Flash memory, or other data storage elements.

The transformation & loading services 310 may be responsible for preparing new data for analysis. These services may be triggered by the scheduling service 314 on a schedule, and may perform a variety of transformation and loading tasks on data stored in the data lake 308. The transformation & loading services 310 can read data from the data lake 308, and write results to both the data lake and the data warehouse of user-facing data 309. The steps performed by the transformation & loading services 310 may be as follows:
Deduplication—data that is retrieved by the integration service 306 may be deduplicated (e.g., identical or otherwise duplicative data entries can be removed or ignored for data processing) in order to promote accurate downstream results.
Enhancement—retrieved data may be enhanced with additional lookup data not provided by the source integration, for example GeoIP location data and Browser/Client threat data. The data may also be enhanced with entity relationship references to support an analytical understanding which entities in the data are related.
Calculate Statistics—to support downstream analytics, various statistics may be calculated atop the incoming data, such as counts of events, event count aggregations such as averages and standard deviations, and potentially any other aggregate statistics that could support Insights.
Stage & Load—transformed data and calculated statistics may be staged to the data lake 308, and then loaded to tables in both the data lake and data warehouse of user-facing data 309 to support analysis by the analysis services 312 and query by the web application 316, respectively.
   Once data has been processed, the transformation & loading services 310 may send a notification to analysis services 312, or forward scheduling instructions from scheduling service 314, regarding performing analysis on the transformed data.

The analysis services 312 may be responsible for performing complex computations and analyses across the entirety of the data stored in the data lake 308. The analysis services 312 may drive the creation of the actionable information produced by the RMSP, and may be triggered on a configurable schedule by the scheduling service 314, either directly or via another component such as transformation & loading services 310. The primary steps performed by the analysis services may be as follows.

Entity Resolution—In order to correlate data and statistics across disparate integrations, the RMSP can use its knowledge of entities and their attributes and relationships in order to make assertions about which distinct entities are actually the same entity. For example:
Identity A in Integration A may be uniquely identified with ID: 123, Email Address: identity@integration.com, and Display Name: “An Identity”
Identity B in Integration B may be uniquely identified with ID: 342 and Email Address: identity@integratoin.com and Display Name: “Identity”
   The RMSP can use its knowledge of these unique identifiers (or “aliases”) to reliably assert that Identity A and Identity B are actually the same Identity (Identity C) and thus that all direct observations made about Identity A and Identity B can be correlated and associated with Identity C. Entity resolution can be performed for any Entity types (e.g., Identity, Endpoint, etc.), but in the examples herein will be focused on Identities, e.g., Users or User Accounts. The results of the entity resolution step may be stored in the data lake 308 and the data warehouse of user-facing data 309.

Insight Calculation—statistics calculated by the transformation & loading services 310 and that are associated with entities resolved by the entity resolution operation can support the generation of insights, e.g., evaluations of what behaviors or activity trends for an Identity may represent risky or notably safe behavior. The results of the insight calculation step may be stored in the data lake 308 and the data warehouse of the user-facing data 309.

Risk Score Model Evaluation—after insights are calculated, the risk score model can be evaluated for each Identity. A risk score may be produced for Identities, which may represent a numerical score, grade, or conclusion regarding the risk presented by an Identity (e.g., Bob is high risk today). The results of the risk score model evaluation step may be stored in the data lake 308 and the data warehouse of the user-facing data 309, and may also be provided to notification service 324.

The notification service 324 may be responsible for communicating information or alerts to end users, and can support email, chat messaging, texts, or other notification methods or formats. The RMSP may utilize the notification service 324 to engage users with information of relevance to them, such as a periodic summary of their insights and risk scores, or near real-time communications about recent behaviors or insights that have been detected and that the users should be made aware of. The notification service 324 may be triggered by the scheduling service 314, for example by activating a module configured to initiate notifications based on analytical artifacts that are stored in the data lake 308 (e.g., Insights, HRI results, etc.), based on risk scores from the analysis service 312, or other triggers. The triggers may be processed by an event bus, which may obtain and provide risk information from the analysis service 312, data lake 308, or user-facing data 309 to a notification handler that determines a medium by which to provide the notifications (e.g., via email, chat, etc., according to default configurations or user-selected preferences). In some examples the notification service 324, or another module of private network 302, may receive data values, and format them into human-parsable notification messages. For example, the risk data from analysis service 312 may include an “Identity” field, a “risk score” field, and a “time period” field, and the notification service 324 may generate a message stating, “Bob has exhibited risky web behavior over the last day.”

The user-facing data 309 may include data accessible to end users, or information about transactions with end users. For example, user-facing data 309 may include a data warehouse of security evaluations, insights, risk scores, and other risk management data useful to users. In some examples, the data lake 308 may store authoritative base data, observations, and derivations upon which the security analysis is performed, while the data warehouse of user-facing data 309 may be data formatted or selected for user review. The data in the data warehouse may be a subset of data from the data lake 308, or data derived from event information in the data lake. The data warehouse may be a separate data structure from the data lake 308, or may be a portion of the data lake 308 configured to be accessible to users outside of the RMSP. The user-facing data 309 may also include a transactional storage data structure or module, which may maintain information pertaining to user access of the user-facing data 309. For example, the transactional storage may maintain access controls or permissions for user access to the data, a log or history of accesses to the data warehouse by users, or other transaction-related instructions or details.

The data on events, statistics, insights, dispositions or risk scores, and segments, for example stored to the user-facing data 309, may be provided or accessible to end users via a UI (user interface) service such as web application 316. The web application 316 may integrate content delivery networks (CDNs) or API-based access to provide web-based, app-based, or other access for end-users to the RMSP 302 system. End users may need to provide authentication or security credentials to access the web application 316 and the RMSP data. For example, a user's security credentials may be authenticated or verified via one or more authentication (AuthN), authorization (AuthX or AuthZ), or SSO (single sign-on) modules or services 318. Additionally, various communications between RMSP private network 302 and external systems, or within private network 302, may employ encryption or security protocols, such as KMS (Key Management Service) & IAM (Identity and Access Management). In some examples, web application 316 and notification service 324 may be integrated, such as requiring successful user authentication via the web application 316 to enable receipt of notifications via the notification service 324. In another example, the notifications sent via notification service 324 may include links to access additional details via web application 316.

The RMSP system 302 may generally feature security infrastructure 320, providing features such as role-based access control and per-tenant encryption. Similarly, the RMSP 302 may feature operations and monitoring infrastructure 322, enabling features such as logging and alerting, and infrastructure as code.

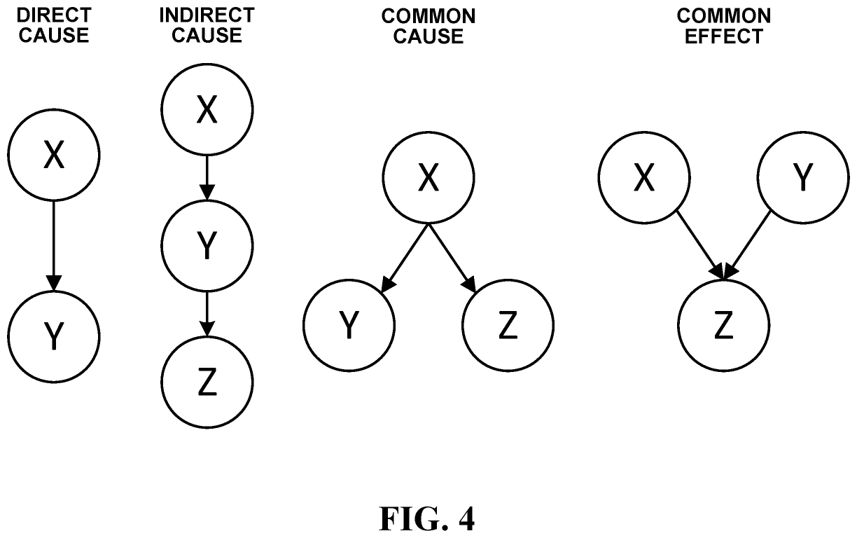

Turning now to FIGS. 4 through 10, an example methodology is discussed for performing risk scoring or calculations based on events. The proposed methodology can be used to score people (identities) and devices (endpoints), can differentiate subsets of entities (e.g., a “segment”) by risk, in numeric or ordered categorical fashion, and may be used to aggregate risk scores over a subset of entities, such as a team, department, or organization. The scores generated by the proposed methodology are explainable in a manner that can allow an end user to understand why entity A is deemed riskier than entity B, understand what activities or insights would bring an entity's risk back down, and understand why an entity's score changed between two points in time.

A probabilistic graphical model (PGM) is a flexible technique for representing the dependencies between multiple variables and how those variables are related to some (probabilistic) outcome. There are a variety of applications for PGMs, and this is meant to provide an overview of how they can be used. PGM techniques can be used for modeling complex probability distributions and estimating the likelihood of variables that aren't directly observable or measurable (e.g., “human risk”).

There may be a variety of possible approaches under the “PGM” umbrella. The example approach discussed herein may employ a Bayesian (or “belief”) Network (BN). An example diagram of BN's is shown in FIG. 4. BN's can codify the joint probability of several random variables by organizing them as a directed acyclic graph (DAG), where the nodes represent random variables, and the edges define conditional dependencies among those variables. In particular, a causal BN (CBN) is one where each directed edge xy in the DAG represent a causal relationship. Examples of the types of causal relationships codified in a CBN are shown in FIG. 4, including direct cause, indirect cause, common cause, and common effect.

A CBN may be used in the examples here (as opposed to other types of graphical models) because a) it's more interpretable than other more generic types of BN's (e.g., X affects risk score S directly or indirectly via some path in the network), b) it's more intuitive for a modeler to build and modify over time, and c) they're convenient for single- and multi-class classification tasks (e.g., by funneling all modeled variables into a single downstream sink node, representing the score class).

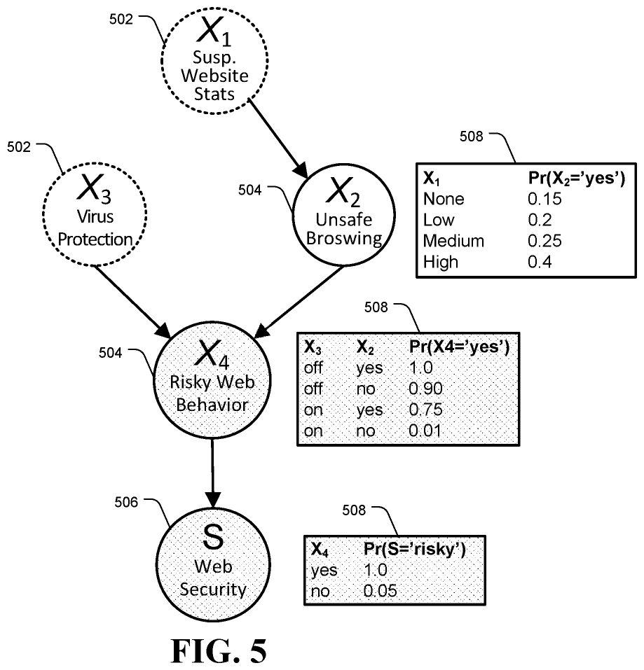

A CBN example is depicted in FIG. 5. Example CBNs, as in FIG. 5, may have multiple layers of nodes. Input or observation nodes 502 may represent a “top” level of a node network, where observable input values may be fed into the system. The CBN may further include one or more hidden, internal, interior, derived, inference, or insight nodes 504, which may be used to predict or estimate some value based on values from one or more parent nodes, and may provide their values to further child nodes. There may be multiple levels of internal nodes 504, where an internal node may be a parent to another internal node, such as how the internal X₂ node (unsafe browsing behavior) is a parent to the internal X₄ node (risky web behavior). Finally, a CBN may include one or more output or decision nodes 506, which may provide an output for the graph based on its own parent nodes.

The CBN depicted in FIG. 5 can be used to codify variables that affect whether a user's web security level is risky (decision node S), based on contributing factor nodes X₁ (a number of suspicious websites visited), X₂ (unsafe browsing behavior), X₃ (whether virus protection for the user is on), and X₄ (whether the user exhibits risky web behavior). Initial interpretability of the causal relationships among the modeled variables is high—the user's web security level is risky if the user exhibits risky web behavior. Moreover, when the user's risk due to web behavior (X₄) is known, all other variables may be irrelevant in estimating the user's web security level. Further, if it is known that the user practices unsafe browsing (X₂), the specific suspicious website stats (X₁) may be irrelevant (though if the user's browsing practices are not known, the suspicious website stats may be useful in predicting whether the browsing behavior is unsafe). These are all examples codifying conditional independence.

By associating conditional probability tables (CPT) 508 with each non-input node (e.g., for internal 504 and output 506 nodes), a full model can be generated that allows the RMSP to estimate the values of some variables given others. Input nodes 502 may not require CPTs 508, as the values for these nodes may be directly known or observed. For example, the “virus protection” and “suspicious website stats” nodes are input nodes 502 using factors that can be observed, and thus don't have any associated CPT 508. Every other node may have a CPT 508 that defines the probability of its value given the values of any of its parent nodes. This example uses all discrete distributions (and all except for X₁ are binary), but any type of distribution function (e.g., continuous, discrete, or piecewise-defined) mapping the inbound nodes to the outbound distribution can be used.

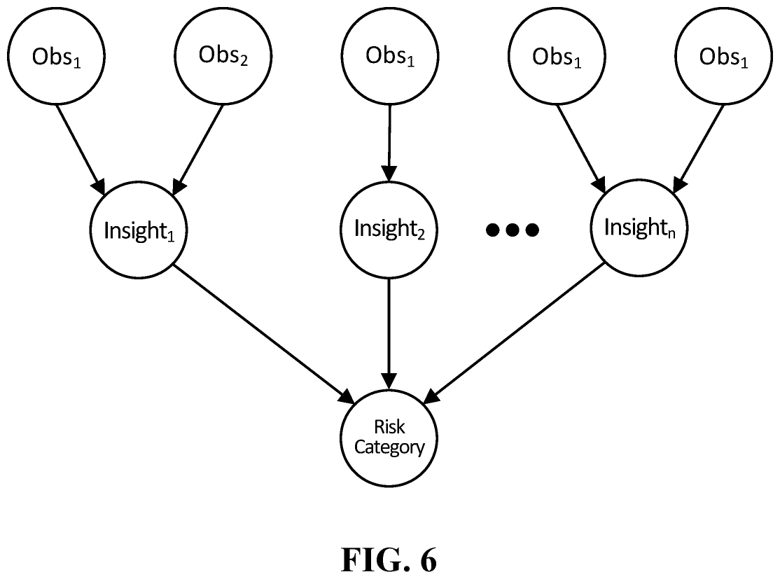

This model allows for inferences like: How likely is it that the user's web security level is risky when the user has visited no unsafe sites but their virus protection is off? The answer, for the example CBN in FIG. 5, is −91.9%; briefly:
Probability that the user's browsing is unsafe is 0.15 (probability of unsafe browsing with no suspicious websites visited in the CPT for X₂).
Probability that the user has risky web behavior is 0.15*1.0 (probability that the user's web behavior is risky when the user's browsing is unsafe and virus protection is off)+0.85*0.90 (probability that the user's web behavior is risky when their web browsing is safe and virus protection is off)=0.915. This can represent the two possible probability outcomes from X₂ (15% unsafe, or 85% safe) multiplied by the first two probability values from the CPT of X₄, corresponding to the options for the virus protection of X₃ being turned off.
Probability that the user's web security level is risky is 0.915*1 (probability that the web security level is risky when the user has risky web behavior)+0.085*0.05 (probability that the web security level is risky when the user does not have risky web behavior)=0.91925
   As demonstrated, causal belief networks can be used to predict some downstream outcome given a set of known, observable inputs 502, with one or more layers of inference nodes 504 that lead to the downstream outcome 506. Notice that in this case, some probability was reserved for the user's web security level to be risky even in the absence of risky web behavior. This approach can be used for generically modeling unknown components in the system. FIG. 6 provides an example CBN illustrating the observable input nodes, the insight or inference nodes, and a predictive or categorizing prediction node.

FIG. 6 is a diagram of a risk scoring model of a risk management security system, in accordance with certain embodiments of the present disclosure. In the case of a risk management security platform as described herein, a CBN can be used to represent causal relationships between observed activity, the insights that are derived from the activity (or are provided via an external source), and an associated risk category. The graph structure of the CBN provides a visual and interpretable analytic hierarchy of how a user's underlying activity gets mapped to one or more insights, and ultimately how those insights can be combined into a score for a given security category—specifically the likelihood that a user is a risk, given the insights that are derived about them. FIG. 6 provides a generic structural diagram of this action/insight/security category dynamic, represented as a graph. The “Obs” nodes may represent different observable behaviors or known risk modifiers, the “Insight” nodes may represent insights or conclusions derived from the related observed behaviors, and the “Risk Category” node may represent a risk conclusion for the related insights. There may be a separate CBN graph for each risk category, with each graph having its own related insights and observable behaviors. More complex graphs may also be used, potentially looking for different combinations of activities or insights to reach downstream inferences.

Initial probability tables may be constructed by hand, which can allow for tuning the impact of any single insight on the overall probability of risk for the given category. Systems may be designed to incorporate machine learning or AI algorithms to automatically adjust weights and probabilities within the probability tables. Hybrid or mixture models may also be used, whereby the model is partially influenced by subject matter expertise and partially learned from data through machine learning or AI algorithms.

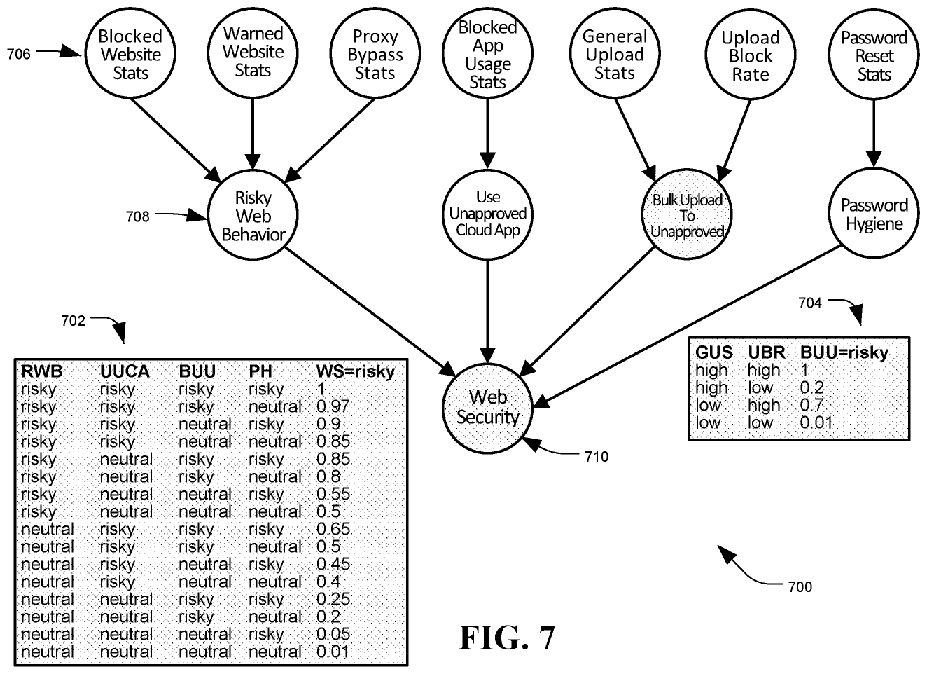

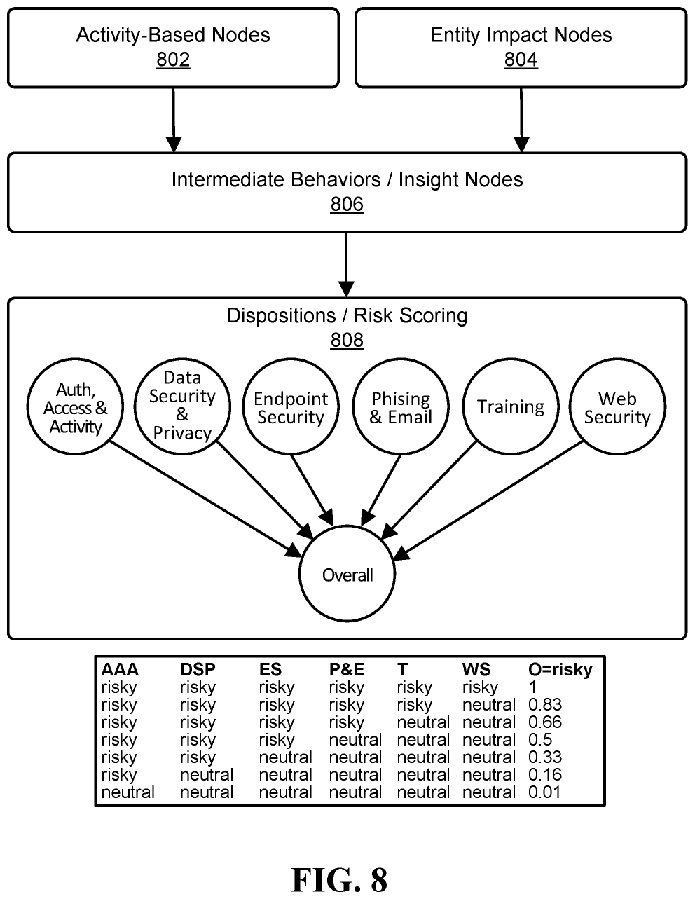

Turning now to FIG. 7, a more specific example of a risk scoring model is shown. An example RMSP (e.g., corresponding to an example model of FIG. 8) may employ the following risk categories:

### 1. Auth, Access & Activity

### 2. Data Security & Privacy

### 3. Endpoint Security

### 4. Phishing & Email

### 5. Training

### 6. Web Security

FIG. 7 depicts a sample BN 700 that builds insights into a categorical risk score for the “Web Security” (WS) category. Sample CPT's for the web security category node 710 and one of the internal insight nodes 708 (for bulk uploads to an unapproved location, BUU) are shown (e.g., CPT 702 corresponding to node 710, and CPT 704 corresponding to the BUU node from insight node layer 708). Note that the size of each CPT may be governed by the number of its incoming variables, e.g., the space of possible combinations of values over those variables. A few things to note about this example:

1) The example uses all discrete binary distributions (so each CPT has 2ⁿ rows, where n is the number of incoming nodes). There are ways to generalize some of these distributions, e.g., to predict WS=risky 100% of the time whenever UUCA (Use Unapproved Cloud App) is risky, in which case half the rows in the web security CPT 702 could be set to 1. However, there is no restriction on the type of distribution used. For example, nothing precludes a system from using [High, Medium, Low, None] as the possible discrete states for the security category node 710. In practice, it may be desirable to have a single node and categorize the computed probability WS=risky, but that is neither a requirement nor a restriction on the modeling approach.

2) As the size of the BN 700 grows, there are techniques for combining sets of related internal nodes (insights) 708 into subgraphs that feed into the downstream risk category 710 through a single node. Similar to how the RWB (Risky Web Behavior) insight takes into account three different input node 706 metrics directly, instead the BN 700 could be constructed so that multiple insight nodes 708 related to similar metrics may be identified that all ultimately feed into the RWB node (e.g., a hypothetical “repeat risky web offenders” insight node 708). The BN framework supports this type of modification as the number of inputs becomes more complex.

3) While the example of FIG. 7 is drawn as a tree, the only restriction imposed on the relationships among the nodes is that a) they imply a causal relationship as discussed earlier, and b) there are no cycles in the graph. Additional restrictions may be imposed, like separating the “input” observed nodes 706 from the internal “insight” nodes 708, and by having a single security category as a downstream node 710, for example to improve convenience to the modeler or to improve model interpretability. It is possible to have metrics or even insights that have a causal relationship with multiple insights. For example, the BN 700 can be designed to have observed metrics around “Upload Block Rate” to have a causal relationship with the RWB insight in addition to the BUU (“Bulk Upload to Unapproved”) insight. Then a UBR RWB edge can be added to the network, and the RWB node's CPT can be updated.

When constructing a BN model, there may be two areas to focus on:
1. Determining the network structure, e.g., the causal relationships to include in the model; and
2. Constructing the CPT's for each internal node 708 and 710, e.g., codifying the state probabilities at each node based on the states of its incoming nodes.

Turning now to FIG. 8, a model for deriving an overall risk score from individual security category scores is shown. This can be done in a basic fashion, e.g., the fraction of risky categories is the probability that the user is risky overall. Alternatively, a more customized relationship between the categories and the overall score can be used, since different categories can have different weighted impacts on overall risk, and some combinations of categories may imply much higher risk than the sum of the categories.

In the example embodiment, the model may consider various types of observation or input nodes, such as activity-based nodes 802 and entity impact nodes 804. The activity-based nodes 802 may provide data on actual entity behavior, such as the number of high-risk websites accessed or upload statistics from the example observation or input nodes of FIG. 7. Activity-based nodes 802 may also represent insights received from external event sources. The entity impact nodes 804 may provide impact modifier data for a given entity, such as attributes of an entity that could affect their risk score. For example, an executive-level employee or one with heightened security access may present a higher security risk than a low-level or restricted-access employee, if their accounts were compromised.

The intermediate behaviors or insight nodes 806 may draw conclusions on certain categories based on their corresponding input nodes. For example, the “Risky Web Behavior”, “Password Hygiene”, etc. nodes of FIG. 7 may provide risk estimates on their respective categories. In some examples, there may be multiple levels of insight nodes 806, with insight nodes serving as inputs to further insight nodes.

The various intermediate behavior or insight nodes 806 may then provide input to one or more disposition or risk scoring nodes 808. There may only be a single disposition or overall scoring node, or there may be multiple layers, such as having a scoring node for each of multiple categories that feed into a single overall scoring node. In the depicted example, the nodes for Authorization, Access & Activity, Data Security and Privacy, etc. are grouped into the dispositions or risk scoring box 808, but may instead be classified as intermediate or insight nodes 806. An example CPT is provided showing the overall probability that a user is “risky” based on the final set of insight nodes.

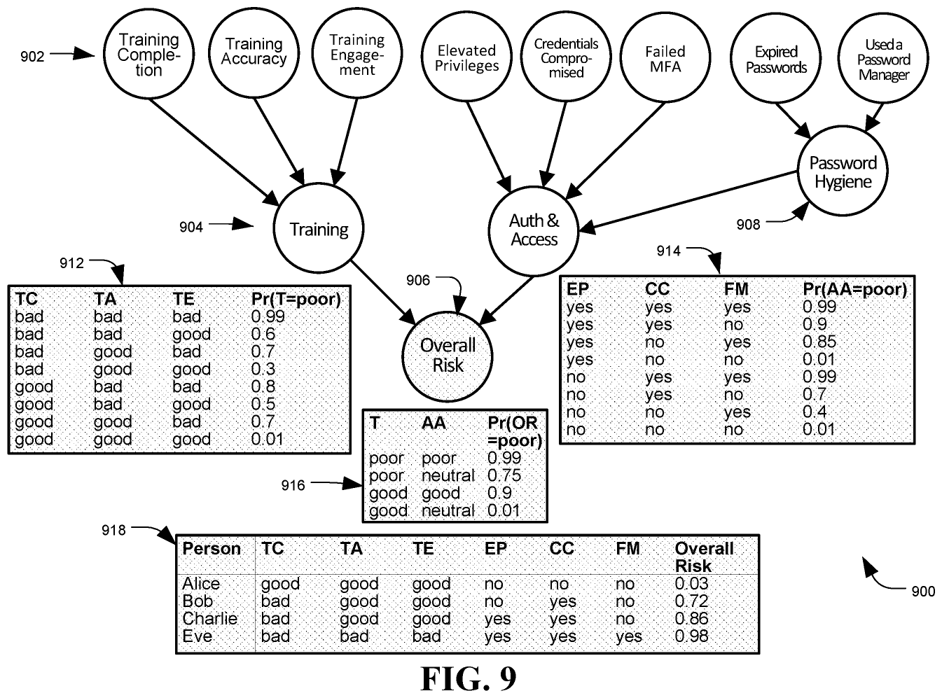

Turning now to FIG. 9, another example BN 900 of a risk management security system is presented. The BN may include a set of input nodes 902 related to observable behavior or entity characteristics, a set of intermediate nodes 904 and 908, and an overall risk scoring node 906. Both the intermediate nodes 904, 908 and the overall risk scoring node 906 may be examples of predicted or calculated nodes that generate estimates or calculated values based on one or more input nodes. A subset of the nodes, including intermediate nodes 904 and 908 as well as some input nodes 902, may provide or form the basis for insights that can be provided from the system to users.

In addition, a number of CPTs are depicted, with a training CPT 912 and an authorization and access CPT 914 corresponding to the security category intermediate nodes 904, and an overall risk CPT 916 corresponding to the overall risk node 906. Finally, an entity risk table 918 is depicted, showing the predicted overall risk for a number of employee entities based on their corresponding input node 902 values.

Input nodes 902 may provide data on observed activity, entity impact or amplifier information, or other observable or known security metrics. For example, the “Failed MFA (multi-factor authentication)” insight may be active for an entity if they have had any failed MFA activity within the past 30 days, and it may remain active for 30 days past the most recent occurrence. Meanwhile, entity amplifiers, a.k.a., influencers, impact nodes, or attribute-based modifiers, such as the “elevated privileges” node, may be facts about an identity that amplify risk from any activity-based insights. Of note, these may not necessarily raise an entity's risk without some associated activity.

The predicted or calculated nodes may include the training and authorization and access (A&A) nodes 904, the password hygiene node 908, and the overall risk node 906. The training and A&A nodes 904 may be examples of broad security categories, wherein the nodes may generate or estimate a generalized risk assessment for an entity within that security category based on the corresponding input nodes 902. These security category risk assessments may be used as inputs in generating an overall risk score (e.g., at overall risk node 906), but may also be used as inputs to other intermediate nodes, for use in determining action plans to improve risk in entities or segments, or for other processes of a risk management security system.

The overall risk node 906 may be a special sink node for capturing weighted inputs from all security categories into a single risk variable. Estimated probability of risk being “HIGH” (or probability of the overall risk being “poor”) on this node may ultimately be how a RMSP produces a single risk value or risk score.

Intermediate behavioral nodes, such as the password hygiene node 908, may be predicted or calculated nodes that receive observable input from input nodes 902, but provide input to other intermediate nodes, such as the Authorization and Access node from the security category nodes 904, rather than to a final scoring node 906. As the number of insights grows, there may be some natural grouping of human behaviors within each security category 904. These tend to emerge naturally as the corpus of insights grows. The “Password Hygiene” node 906 is included as an example of an intermediate node, but is omitted from the A&A CPT 914 and further consideration in this modeling example of FIG. 9 to reduce complexity.

With the CPT's 912, 914, and 916 for each of the non-input nodes defined, example values can be simulated for the input nodes 902 and demonstrate the predicted probability that the “Overall Risk” variable is in a “poor” state. The table 918 provides example entities and their observed insights, where the final column calculates the probability that each person's “Overall Risk” is in the “poor” state, Pr(OR=poor).

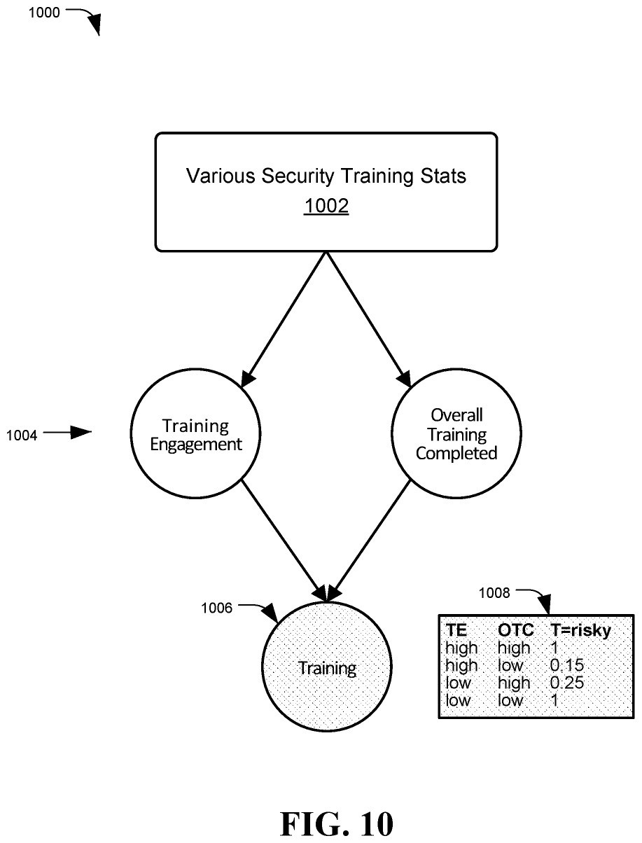

A few observations may be made from the table 918. Generally, more risky input states imply higher overall risk. All positive input states (Alice) may yield the notional lowest probability of risk, while all negative input states (Eve) may yield the notional highest probability of risk. Bob and Charlie have identical input states, with Charlie additionally being flagged as having “Elevated Privileges”. This can lead to a higher probability of risk for Charlie by design in the “Auth & Access” probability table shown in the diagram above. An example of integrating data from a security training system into a RMSP risk assessment model is illustrated in FIG. 10.

FIG. 10 depicts a model 1000 showing that security training results 1002 can be integrated initially as an observed node 1004 that feeds directly into a Training security category 1006. Security training stats and scores 1002 may be obtained from or provided by a security training vendor, software program, or other security training sources. The “Various Security Training Stats” 1002 could be a training program's overall security score itself (and any observations of how it has changed over time) as well as any of the inputs to the security score, e.g., positive/negative answer metrics, and completed episode/module counts. For example, individual elements from the various security training stats 1002 may be broken out into individual inputs for observed nodes 1004 for training engagement and overall training completion. From these inputs, a “training” security category node 1006 could generate an estimated risk score for this security category via a CPT 1008.

As an example, the RMSP may employ a module, software, or processor for receiving a bundle of training stats 1002 from a security training vendor system (e.g., via an API), and extracting and normalizing the individual training stat component data for use in the RMSP's risk scoring model. This solution may integrate a security training score and its input statistics into the RMSP's risk score, without requiring any sort of overhaul of the security training scoring solution. Alternately, a security training score (or some portion of it based on inputs provided by the training program) can replace the RMSP's Training scoring function. Insights from a security training program can also be integrated to provide useful summary information for the end user.

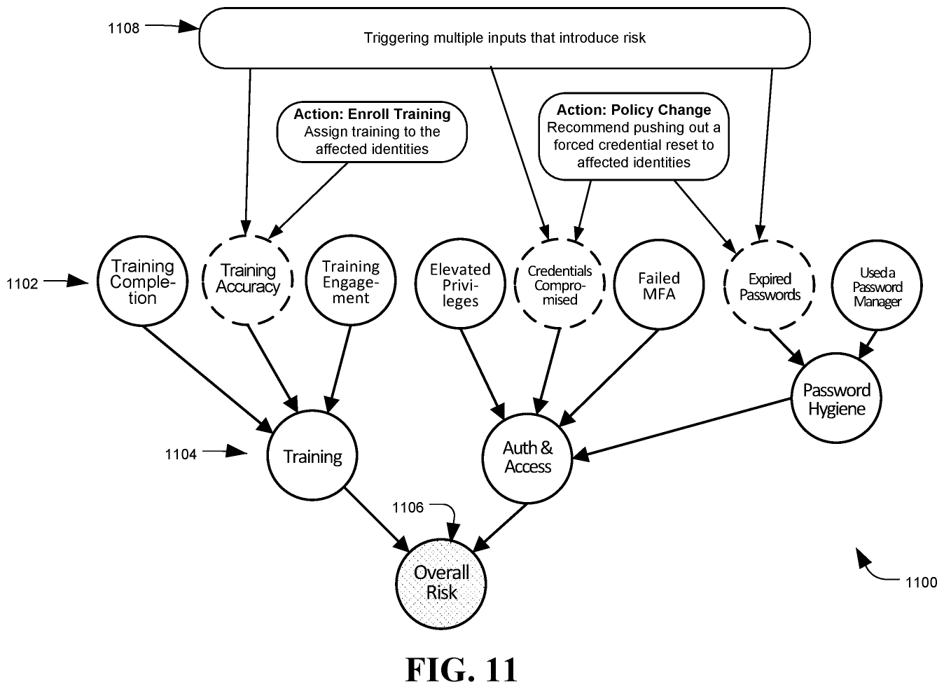

Turning now to FIG. 11, a diagram of a system 1100 for providing action plans based on a risk management system is shown and described. The risk scoring model of system 1100 may correspond to the model depicted in FIG. 9, including a plurality of input nodes 1102 that feed into intermediate security category nodes 1104, which in turn provide input for an overall risk scoring node 1106. The system 1100 may be implemented via RMSP 102.

The system 1100 may include identifying one or more input nodes 1102 that introduce or identify risk, at 1108. The input nodes 1102 corresponding to elevated risk may have dashed lines, corresponding to training accuracy, compromised credentials, and expired passwords in this example. The triggering criteria may be based on some value being above or below a threshold (e.g., Bob scored below a 70 in training accuracy), or having a particular score or rating (e.g., compromised credentials=yes; training accuracy=bad). For example, the input nodes 1102 may be for raw data (e.g., a training test score for training accuracy), or the input nodes 1102 may be a form of insight nodes, where they provide an assertion or conclusion derived from raw data (e.g., Bob's training accuracy is “bad” based on an input training score). In some examples, intermediate nodes 1104 may be used instead of or in addition to input nodes 1102 as a basis for determining when suggesting or implementing an action plan is warranted, and selecting appropriate action plans.

The input nodes 1102 associated with introducing risk at 1108 may be identified whenever a node 1102 produces a certain value or exceeds a threshold, or the specific identification of risky input nodes may be triggered by some event. For example, if the values of intermediate nodes 1104 or the overall risk score 1106 for an entity exceeds a threshold, or if a user requests that the RMSP produce an action plan to reduce risk, the system 1100 may then identify the risky input nodes.

Based on the identification of the triggering risky input nodes 1102, the system may generate an action plan configured to reduce the triggering risk element. Action plans may be a set of proposals provided to a user of the system 1100 (e.g., based on a request for an action plan or based on a risk report including entities or segments having a high risk probability), or action plans may be implemented automatically by the RMSP (e.g., by locking a user account until a compromised password is reset, or emailing a user a link to a training course associated with the risky input node 1102).

In the depicted example, a “training accuracy” input node may indicate risk from an Identity (e.g., a user). The proposed action plan may be to assign a training course to the Identity that could improve the Identity's training accuracy. For the “credentials compromised” and “expired passwords” input nodes, a remedial action plan may be for a policy change or update, such as requiring the corresponding Identities to reset their security credentials.

Action plans may include a set of pre-configured options or operations that may be implemented automatically, or in which a user or system administrator can select from a set of possible options. For example, whenever an expired password is detected, the action plan may include automatically requiring a password reset before the corresponding user can access the system again, or it may include presenting an email or pop-up invitation to reset their password, with the implemented action plan being selected by a user or system administrator. In some examples, a user or system administrator may input or configure new or personalized action plans for the potential risk triggers. Action plans, including executable code, notification messages, or other components, may be determined and accessed based on a lookup table, using the type of triggering event or input node 1102 as the access input. Certain triggering “events” (input nodes or otherwise) can be linked to criteria associated with action plans, and the system can perform an assessment of which action plan to select based on a lookup of some data structure. Risk assessments, action plans, or both may be presented to users via web application 316 or notification service 324 of FIG. 3.

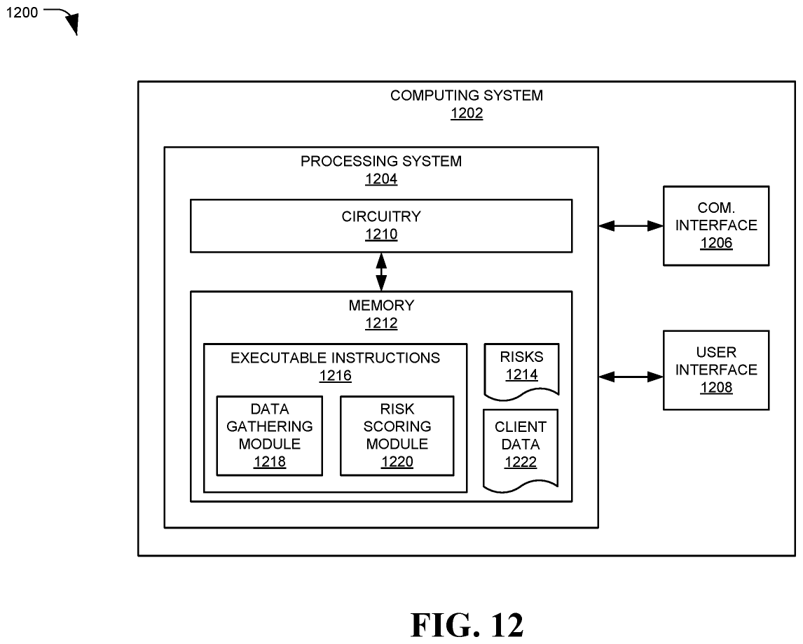

Turning now to FIG. 12, a diagram of a system 1200 configured for implementation of a risk management security system is depicted, in accordance with certain embodiments of the present disclosure. In particular, FIG. 12 depicts a computer system 1202, which may be an example of any computing system that may be employed to perform the operations of client or user systems 106 and 110, risk management security platform (RMSP) 102, security and service vendors 104, and related processes and methods. Computing system 1202 may include a processing system 1204, a communication interface 1206, and a user interface 1208. Computing system 1202 may include other components, such as a battery and enclosure, that are not shown for clarity. Computing system 1202 may comprise one or more server computing systems, desktop computing systems, laptop computing systems, smartphone devices, or any other computing system, including combinations thereof.

Communication interface 1206 may comprise components that communicate over communication links, such as network cards, ports, radio frequency (RF), processing circuitry and software, or some other communication devices. Communication interface 1206 may be configured to communicate over metallic, wireless, or optical links. Communication interface 1206 may be configured to use Time Division Multiplex (TDM), Internet Protocol (IP), Ethernet, optical networking, wireless protocols, communication signaling, other communication formats, or any combinations thereof. In particular, communication interface 1206 may be configured to communicate over a network 114 with RMSP 102, client or user systems 106 and 110, security and service vendors 104, or other external systems. Communication interface 1206 may also enable communication with local external devices, such as local data storage systems.

User interface 1208 may comprise components that interact with a user to receive user inputs and to present media or other information. User interface 1208 may include a display screen, touch screen, touch pad, keyboard, buttons, speaker, microphone, pointer device or interface, communication port, other user input/output apparatus, or any combination thereof.

Processing system 1204 may be linked to communication interface 1206 and user interface 1208. Processing system 1204 can include processing circuitry 1210 and memory device 1212. Memory device 1212 can store executable instructions or other operating software 1216, as well as non-executable data files, such as risk data 1214 and standards and client or customer data 1222.

Processing circuitry 1210 may comprise a microprocessor and other circuitry that can retrieve and execute instructions 1216 from memory device 1212. Memory 1212 may comprise a non-volatile data storage medium, such as a disk drive or solid state drive, or volatile memory such as random access memories (RAM) and dynamic RAM (DRAM), or any other memory apparatus. In some examples, processing circuitry 1210 may be mounted on a circuit board that may also hold memory device 1212 and portions of communication interface 1206 and user interface 1208.

Executable instructions 1216 may comprise computer programs, firmware, or some other form of machine-readable processing instructions. Executable instructions 1216 may include data gathering module 1218, and risk scoring module 1220, although related operations may be handled by multiple different modules or programs (potentially located on multiple computing devices), all operations may be performed by a single module, or additional modules may be included in executable instructions 1216. For example, portions or embodiments of data gathering module 1218 and risk scoring module 1220 may be implemented by RMSP 102, user systems 106 and 110, or a combination thereof. Executable instructions 1216 may further include an operating system, utilities, drivers, network interfaces, applications, or other types of software. When executed by processing circuitry 1210, executable instructions 1216 may direct processing system 1204 to operate computing system 1202 as described herein.

Data gathering module 1218 may be a set of instructions for obtaining information related to risk assessment. At a user system 106 or 110, for example, a data gathering module 1218 may monitor a version history of installed software, web browsing activity, web traffic and data uploads or downloads, or other activity data. Similarly, security and service vendors 104 may include a data gathering module 1218 for recording or determining security training results, email habits, web traffic data, or other information related to one or more users or user systems 106 or 110. RMSP 102 may have a data gathering module 1218 configured to obtain activity data from client or user systems 106 or 110, from security or service vendors 104, or from other sources. Information on known risks or vulnerabilities of different software versions, malicious websites, viruses or other malicious code, or similar general risk data can likewise be obtained via data gathering module 1218. Known risk or vulnerabilities may be stored to a risks data element 1214 for comparison against activity data and identity-specific information. Information on identity activities, user or client preferences, or other user- or client-specific information may be stored as client 1222.

Risk scoring module 1220 may include a set of instructions regarding how to consolidate, compare, and score risk attributes for identities based on data obtained from data gathering module 1218. The risk scoring module 1220 may use information from the risks data element 1214 and client data 1222 to assess and act on risk. For example, risk scoring module 1220 may compare activity data against known risk data to determine risky activity, accumulate or consolidate activity to produce overall statistics on risky activity, generate insights on elements of an identity's risk posture based on the statistics, generate disposition or overall risk scores based on the insights, and group individual identities into segments to provide high-level risk views for groups of identities. The risk scoring module may employ CBN networks to evaluate risk for individual entities and across segments. Further, in some embodiments the risk scoring module 1220 may generate action plans configured to reduce risk based on the client data 1222 and the risk scoring results.

Results of the risk scoring and action plan generation may be presented via user interface 1208, communication interface 1206, or both. For example, the risk scores may be provided via a communication interface 1206 to a notification service, which may push email notifications or chat messages to client systems. Similarly, risk scores or action plans may be provided via a web application through communication interface 1206. An action plan involving security training may be provided to a security vendor 104 via communication interface 1206, which may in turn send a training course or invitation to a relevant user or other identity.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Steps depicted in the flowcharts may optionally be excluded, added, performed in a different order, or performed with different degrees of concurrency than shown (e.g., steps depicted as sequential may be performed concurrently). Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A method comprising:
performing a risk evaluation via a risk management security platform (RMSP), including:
receiving activity data for a risk-oriented event corresponding to a user participant;
generating an insight providing an evaluation of risk for the user participant in a risk category based on the activity data;
generating a risk score for the user participant based on the insight; and
providing a notification based on the risk score.

2. The method of claim 1, the risk evaluation further including:
grouping a plurality of user participants having a shared attribute into a segment;
evaluating a risk trend for the segment based on the risk score for the plurality of user participants; and
generating the notification regarding the risk trend for the segment.

3. The method of claim 1, the risk evaluation further including:
generating the risk score based on a probabilistic graphical model.

4. The method of claim 3, further comprising the probabilistic graphical model includes a causal belief network (CBN), including:
modeling the activity data as input nodes;
generating the insight based on an internal node receiving causal input from the input nodes; and
generating the risk score based on an output node receiving causal input from a plurality of internal nodes.

5. The method of claim 4, further comprising:
modeling the plurality of internal nodes and the output node based on conditional probability tables, with a conditional probability table defining a probability of a value for a corresponding node based on values from parent nodes that provide causal input to the corresponding node.

6. The method of claim 4, further comprising:
modeling the CBN to include:
a first input node representing the activity data for the user participant; and
a second input node representing a risk modifier value for the user participant, wherein certain values for the second input node amplify a risk associated with the first input node.

7. The method of claim 4, further comprising:
modeling the CBN to include:
the plurality of internal nodes, each internal node corresponding to one of a plurality of risk categories; and
the output node configured to generate the risk score representing an aggregate risk for the user participant across all risk categories.

8. The method of claim 1, the risk evaluation further including:
implementing an action plan to reduce risk, including:
identifying activity data having a value that corresponds to elevated risk;
accessing a data structure of remedial actions based on a type of the activity data; and
implementing a remedial action associated with the type of the activity data.

9. An apparatus comprising:
a processor configured to implement a risk management security platform (RMSP) to perform a risk evaluation, including:
obtain activity data for a risk-oriented event corresponding to a user participant;
generate an insight providing an evaluation of risk for the user participant in a risk category based on the activity data;
generate a risk score for the user participant based on the insight; and
provide a notification based on the risk score.

10. The apparatus of claim 9 comprising the processor further configured to:
group a plurality of user participants having a shared attribute into a segment;
evaluate a risk trend for the segment based on the risk score for the plurality of user participants; and
generate the notification regarding the risk trend for the segment.

11. The apparatus of claim 9 comprising the processor further configured to:
implement an integration service to gather and normal the activity data, including:
obtain the activity data from a plurality of third-party sources via application program interface (API) calls; and
convert the activity data from source formats corresponding to each of the plurality of third-party sources into a standard format; and
store the activity data in the standard format to a data structure.

12. The apparatus of claim 11 comprising the processor further configured to:
implement an analysis service to evaluate the activity data from the data structure via a causal belief network (CBN), including:
model the activity data as input nodes;
generate the insight based on an internal node receiving causal input from the input nodes;
generate the risk score based on an output node receiving causal input from a plurality of internal nodes; and
model the plurality of internal nodes and the output node based on conditional probability tables, with a conditional probability table defining a probability of a value for a corresponding node based on values from parent nodes that provide causal input to the corresponding node.

13. The apparatus of claim 12 comprising the processor further configured to:
model the CBN to include:
the plurality of internal nodes, each internal node corresponding to one of a plurality of risk categories; and
the output node configured to generate the risk score representing an aggregate risk for the user participant across all risk categories.

14. The apparatus of claim 10 comprising the processor further configured to:
implement a notification service to provide the notification, including:
determine to provide a notification based on the risk score;
generate a human-parsable notification message based on the risk score; and
select a notification medium from a plurality of notification mediums by which to provide the notification.

15. The apparatus of claim 10 comprising the processor further configured to:
receive a user request for information via a web application; and
provide information regarding the insight via the web application.

16. The apparatus of claim 10 comprising the processor further configured to:
implement an action plan to reduce risk, including:
identify activity data having a value that corresponds to elevated risk;
access a data structure of remedial actions based on a type of the activity data; and
implement a remedial action associated with the type of the activity data.

17. A memory device storing instructions that, when executed, cause a processor to perform a method comprising:
performing a risk evaluation via a risk management security platform (RMSP), including:
receiving activity data for a risk-oriented event corresponding to a user participant;
generating an insight providing an evaluation of risk for the user participant in a risk category based on the activity data;
generating a risk score for the user participant based on the insight; and
providing a notification based on the risk score.

18. The memory device of claim 17 storing instructions that, when executed, cause the processor to perform the method further comprising:
generating the risk score based on a causal belief network (CBN), including:
modeling the activity data as input nodes;
generating a plurality of insights based on a plurality of internal nodes receiving causal input from the input nodes, each internal node corresponding to one of a plurality of risk categories;
generating the risk score based on an output node receiving causal input from the plurality of internal nodes, the risk score representing an aggregate risk for the user participant across all risk categories; and
modeling the plurality of internal nodes and the output node based on conditional probability tables, with a conditional probability table defining a probability of a value for a corresponding node based on values from parent nodes that provide causal input to the corresponding node.

19. The memory device of claim 17 storing instructions that, when executed, cause the processor to perform the method further comprising:
grouping a plurality of user participants having a shared attribute into a segment;
evaluating a risk trend for the segment based on the risk score for the plurality of user participants; and
generating the notification regarding the risk trend for the segment.

20. The memory device of claim 17 storing instructions that, when executed, cause the processor to perform the method further comprising:
implementing an action plan to reduce risk, including:
identifying activity data having a value that corresponds to elevated risk;
accessing a data structure of remedial actions based on a type of the activity data; and
implementing a remedial action associated with the type of the activity data.
